(19) United States
(12) Patent Application Publication
(10) Pub. No.: US 2014/0294125 A1
(43) Pub. Date: Oct. 2, 2014

(54) RECEIVER

(71) Applicant: NTT DOCOMO, INC., Chiyoda-ku, Tokyo (JP)

(72) Inventors: Yuta Sagae, Tokyo (JP); Yusuke Ohwatari, Tokyo (JP); Nobuhiko Miki, Tokyo (JP)

(73) Assignee: NTT DOCOMO, INC., Chiyoda-ku, Tokyo (JP)

(21) Appl. No.: 14/353,931

(22) PCT Filed: Nov. 2, 2012
(86) PCT No.: PCT/JP2012/078471

§ 371 Date: Apr. 24, 2014

(30) Foreign Application Priority Data
Nov. 4, 2011 (JP) 2011-242917

(51) Int. Cl. H04L 27/26; H04L 25/02

(52) U.S. Cl. CPC H04L 27/2647; H04L 25/021; H04L 1/0606
USPC 375/340

(57) ABSTRACT

Appropriate reception processing is performed using a CRS-based estimation method for a covariance matrix R_{I+N}. An IRC receiver 10 according to the present invention includes: a covariance matrix estimation unit 12/13 configured to estimate a covariance matrix R_{I+N} based on a CRS; a missing element insertion unit 14 configured to insert a given value into an inestimable element in an interference-signal covariance matrix R_{I+N} (“˜” is on R) of interference signal components contained in the estimated covariance matrix R_{I+N}; an IRC reception weight generation unit 16 configured to generate an IRC reception weight W_{IRC} by using the control signal and the covariance matrix R_{I+N} having the given value inserted thereinto; and a signal separation unit 17 configured to separate the data signal from a received signal by using the generated reception weight and the control signal.

### TECHNICAL FIELD

The present invention relates to a receiver.

### BACKGROUND ART

In LTE (Long Term Evolution), an IRC (Interference Rejection Combining) receiver configured to suppress interfering beams of other mobile stations UE is discussed as one of methods for improving cell-edge throughput in downlink.

As shown in FIG. 8(a), an IRC receiver 10 aims to improve the received quality of a desired signal by suppressing interference signals.

Further, LTE (Release-8) is configured such that a CRS (Cell-Specific Reference Signal) is transmitted to perform estimation of a channel state (CSI: Channel State Information), demodulation of data signals and control signals, and measurement of received quality in a cell.

More specifically, LTE (Release-8) is configured such that the CRSs are transmitted along with data signals and control signals in a format shown in FIG. 8(b). Note that the CRS can be set for up to four antennas.

Further, LTE is configured to use an SFBC (Space Frequency Block Coding) scheme as a transmission diversity scheme.

The SFBC scheme is configured to use “Alamouti coding” which can achieve the maximum diversity gain at a symbol level equivalent to maximum ratio combining. Specifically, the SFBC scheme is configured to perform coding by using two resource elements (RE) in a frequency direction. These two resource elements are referred to as an “SFBC pair” herein.

A description is given below of a reception signal model for the IRC receiver 10 in a case where, as shown in FIG. 9, the IRC receiver 10 receives a desired signal from a cell 1 (q=1) and receives an interference signal from a cell 2 (q=2), the model ignoring channel fluctuations.

Specifically, formulae shown in FIGS. 10(a) to 10(c) can express a reception signal r₁ (2m) by a receiving antenna 1 (i=1) of the IRC receiver 10 in the even-numbered resource element of an SFBC pair m, a reception signal r₂ (2m) by a receiving antenna 2 (i=2) of the IRC receiver 10 in the even-numbered resource element of the SFBC pair m, a reception signal r: (2m+1) by the receiving antenna 1 (i=1) of the IRC receiver 10 in the odd-numbered resource element of the SFBC pair m, and a reception signal r₂* (2m+1) by the receiving antenna 2 (i=2) of the IRC receiver 10 in the odd-numbered resource element of the SFBC pair m. Note that * denotes a complex conjugate.

Meanwhile, a technique for performing reception processing by using an MMSE (Minimum Mean Square Error) spatial filtering scheme is conventionally known for interference suppression.

This technique is configured to generate an IRC reception weight W_{IRC} (k,l), as shown in FIG. 11(a). To generate the IRC reception weight W_{IRC} (k,l), a CRS-based estimation method for a covariance matrix R_{I+N} shown in FIG. 11(b) is used (see Non-patent document 1).

As shown in FIG. 11(b), the covariance matrix R_{I+N} includes a desired-signal covariance matrix A of desired signal components and an interference-signal covariance matrix B of interference signal components (noise signal components). Hereinbelow, the interference-signal covariance matrix B is expressed as:

\tilde{R}_{I+N}|. [Expression 1]

### PRIOR ART DOCUMENT

### Non-Patent Document

Non-patent document 1: 3GPP contribution R4-115213

### SUMMARY OF THE INVENTION

However, as shown in FIG. 12, based on the CRSs transmitted in a serving cell (cell 1), the IRC receiver 10 can extract only interference from the even-numbered resource element of the SFBC pair in an interference cell #1/#2, i.e., cannot extract solely interference from the odd-numbered resource element of the SFBC pair in the interference cell #1/#2.

Specifically, an interference-signal-component covariance matrix for the even-numbered resource element of the SFBC pair is expressed by Formula (1) shown in FIG. 12 as:

\tilde{R}_{I+N}(2m)|, [Expression 2]

and an interference-signal-component covariance matrix for the odd-numbered resource element of the SFBC pair is expressed by Formula (2) shown in FIG. 12 as:

\tilde{R}_{I+N}(2m+1)|. [Expression 3]

Then, by using Formulae (1) and (2) shown in FIG. 12, an interference-signal-component covariance matrix is expressed as:

\tilde{R}_{I+N}|, [Expression 4]

as shown in FIG. 13. In such a case, each element C in FIG. 13 is either a covariance value between different resource elements of an SFBC pair or is a covariance value between different resource elements of the SFBC pair at different receiving antennas. Thus, the element C cannot be obtained by the CRS-based estimation method for the covariance matrix R_{I+N}.

This problem leads to a problem where the IRC reception weight cannot be appropriately generated, hindering appropriate reception processing.

The present invention has been made in view of the above problems, and has an objective of providing a receiver capable of performing appropriate reception processing by using a CRS-based estimation method for the covariance matrix R_{I+N}.

A first feature of the present invention is summarized as a receiver configured to receive a data signal, a control signal, and a cell-specific reference signal transmitted using a space frequency block coding scheme, the receiver including: a covariance matrix estimation unit configured to estimate a covariance matrix based on the cell-specific reference signal; a missing element insertion unit configured to insert a given value into an inestimable element in an interference-signal covariance matrix of interference signal components contained in the estimated covariance matrix; a reception weight generation unit configured to generate a reception weight by using the control signal and the covariance matrix having the given value inserted thereinto; and a signal separation unit configured to separate the data signal from a received signal by using the control signal and the generated reception weight.

### BRIEF DESCRIPTION OF THE DRAWINGS

FIG. 1 is a functional block diagram of an IRC receiver according to a first embodiment of the present invention.

FIG. 2 is a diagram illustrating a method for calculating a covariance matrix, by the IRC receiver according to the first embodiment of the present invention.

FIG. 3 is a functional block diagram of an IRC receiver according to Modification 1 of the present invention.

FIG. 4 is a diagram illustrating a method for calculating a covariance matrix, by the IRC receiver according to Modification 1 of the present invention.

FIG. 5 is a diagram illustrating a method for calculating a covariance matrix, by the IRC receiver according to Modification 1 of the present invention.

FIG. 6 is a functional block diagram of an IRC receiver according to Modification 2 of the present invention.

FIG. 7 is a diagram illustrating a method for calculating a covariance matrix, by the IRC receiver according to Modification 2 of the present invention.

FIG. 8 is a diagram illustrating a prior art.

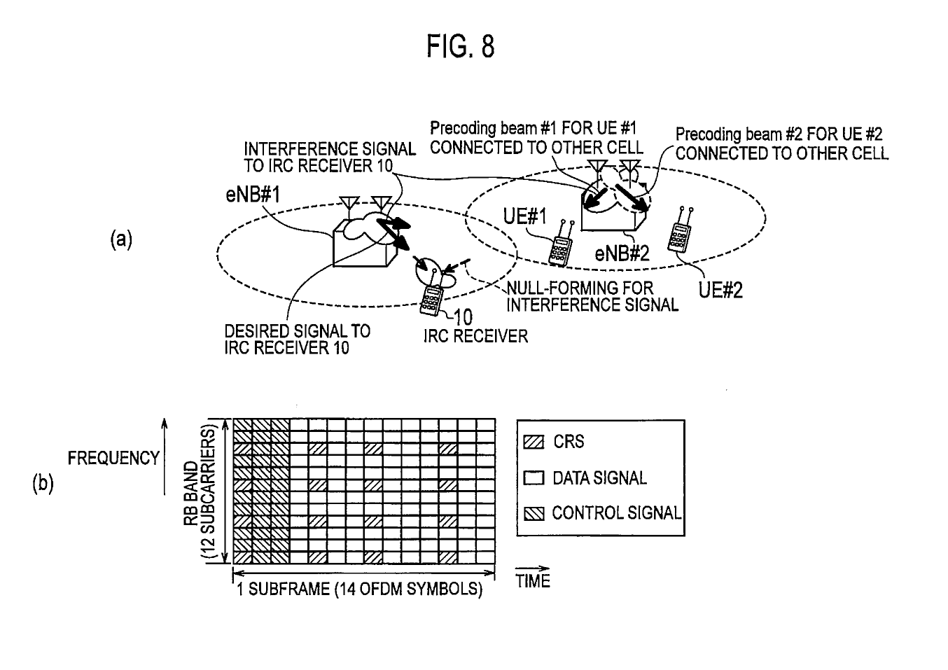

FIG. 9 is a diagram illustrating a prior art.

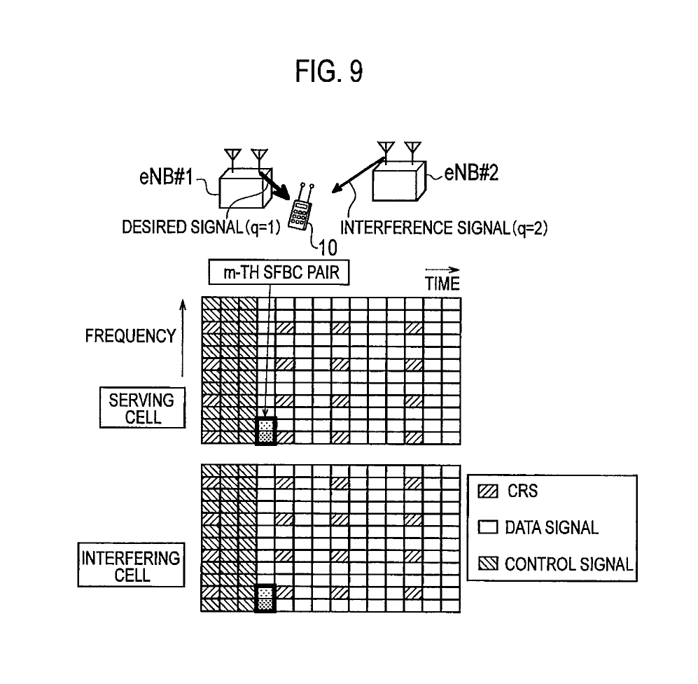

FIG. 10 is a diagram illustrating a prior art.

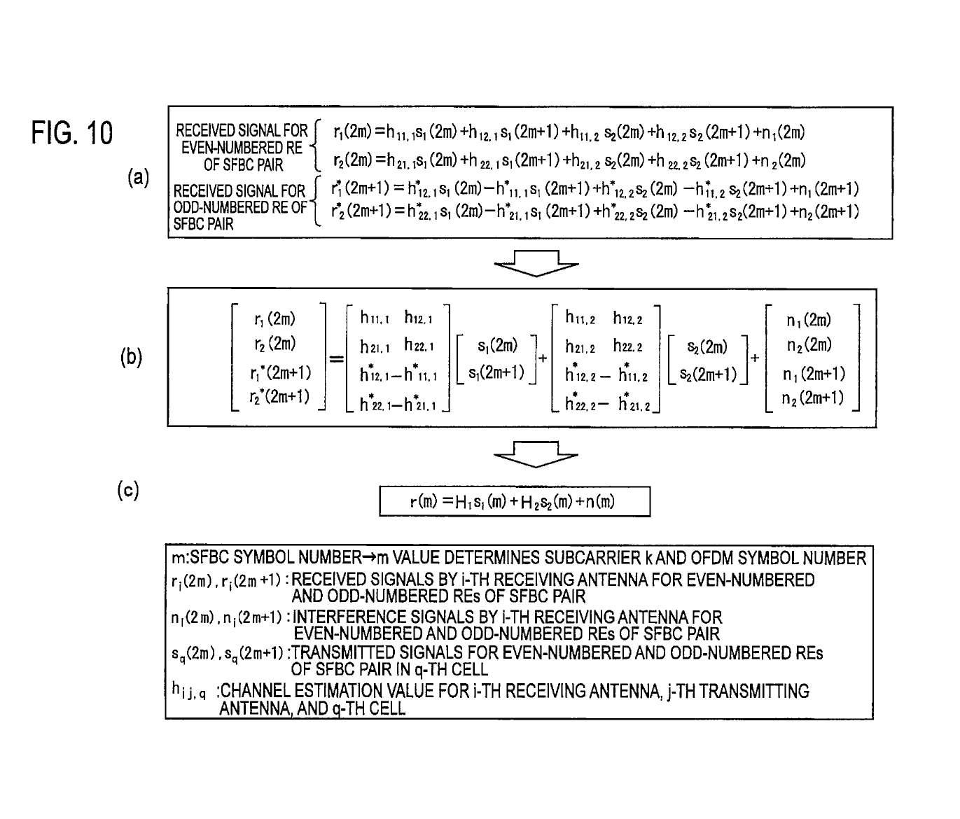

FIG. 11 is a diagram illustrating a prior art.

FIG. 12 is a diagram illustrating a prior art.

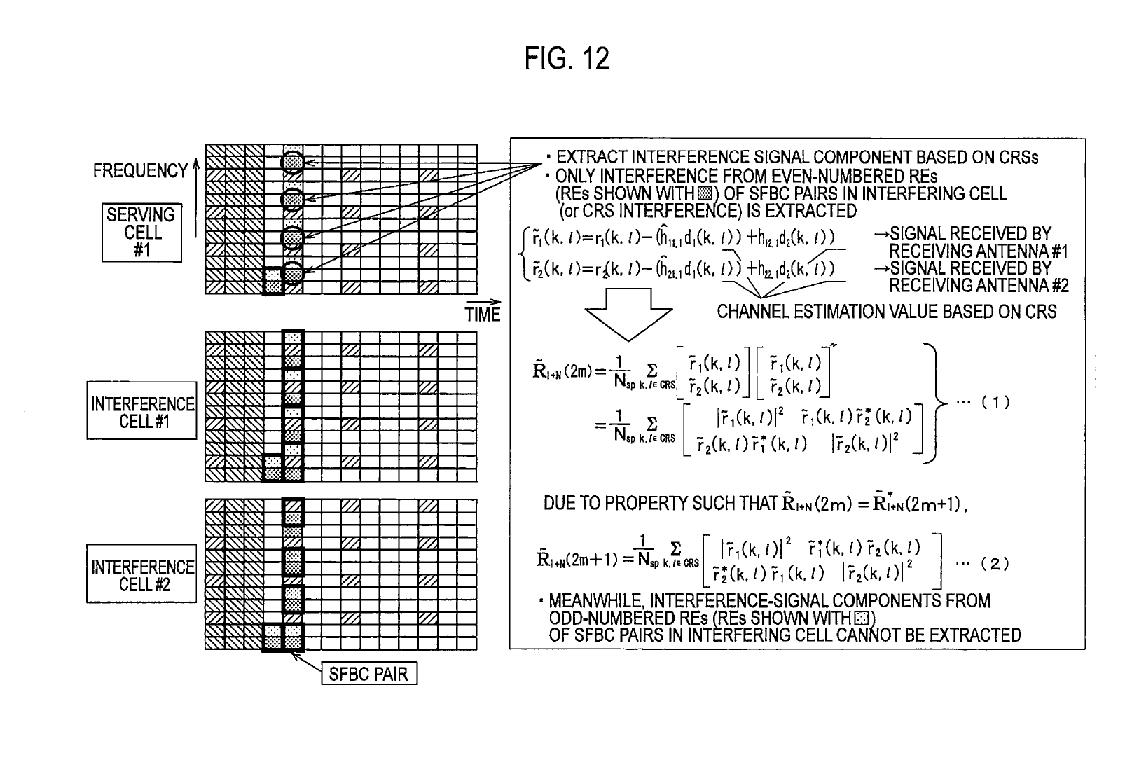

FIG. 13 is a diagram illustrating a prior art.

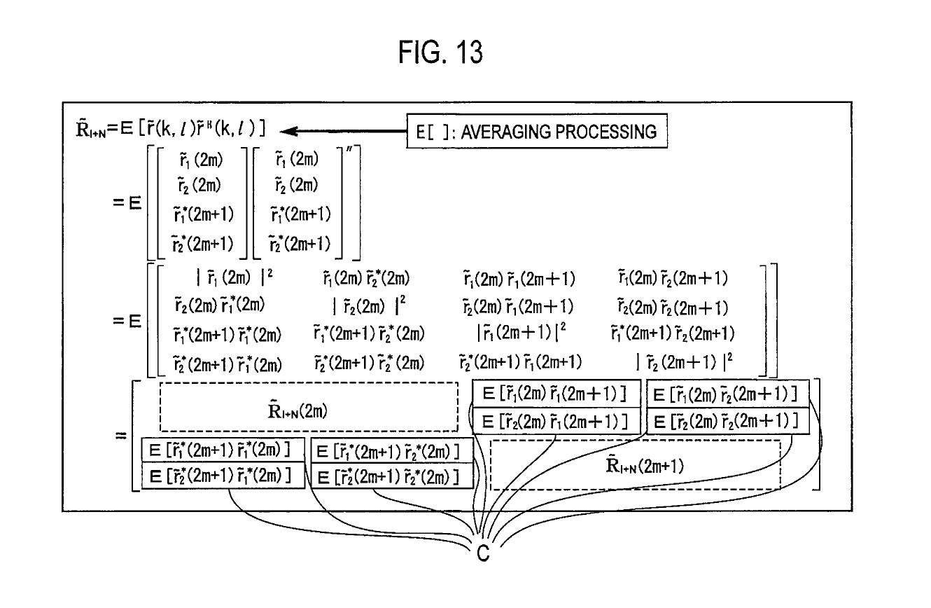

### MODE FOR CARRYING OUT THE INVENTION

### Mobile Communication System According to the First Embodiment of the Present Invention

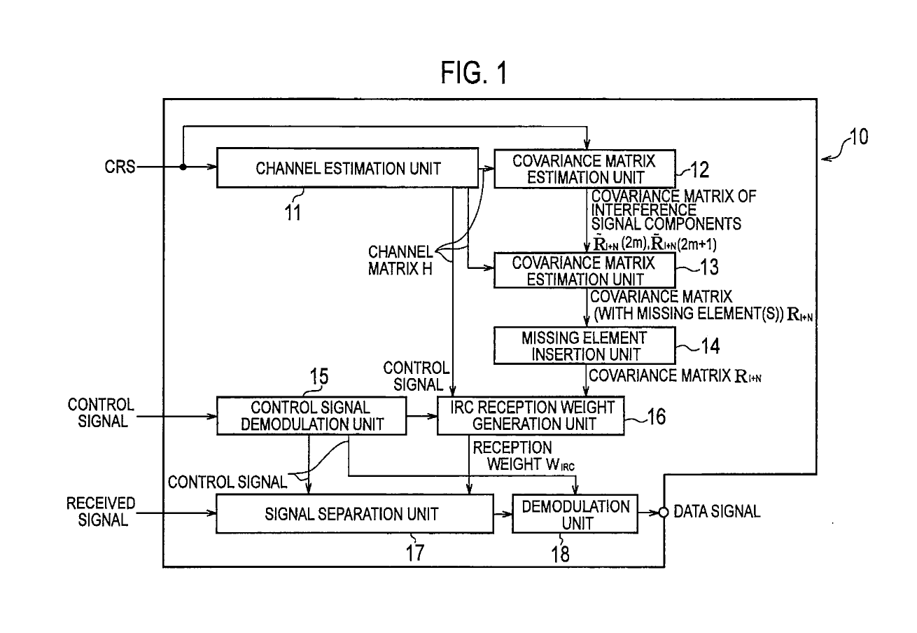

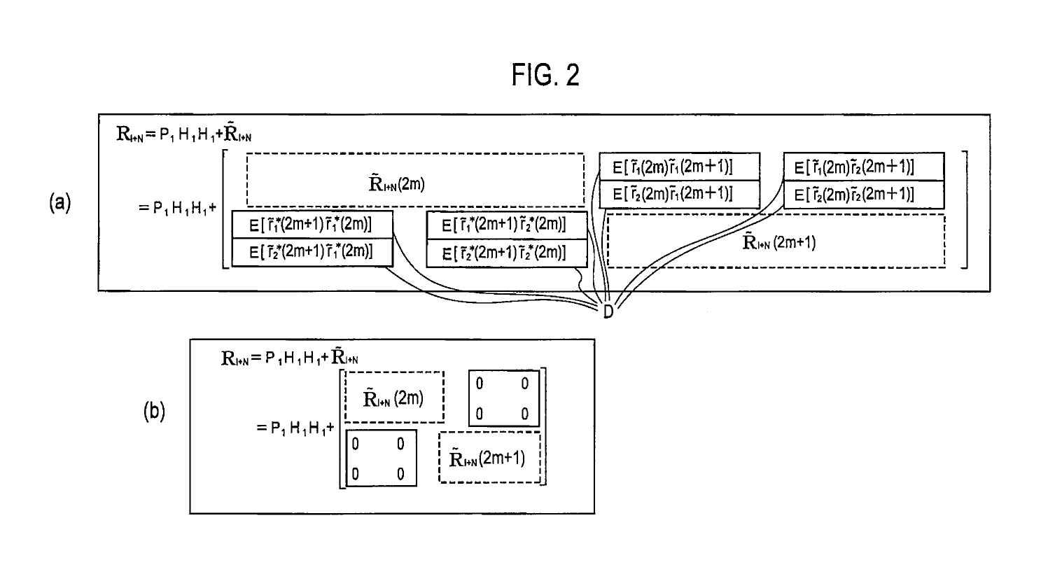

With reference to FIGS. 1 and 2, an IRC receiver 10 according to a first embodiment of the present invention is described.

As shown in FIG. 1, the IRC receiver 10 according to the present embodiment includes a channel estimation unit 11, a covariance matrix estimation unit 12, a covariance matrix estimation unit 13, a missing element insertion unit 14, a control signal demodulation unit 15, an IRC reception weight generation unit 16, a signal separation unit 17, and a demodulation unit 18.

The channel estimation unit 11 is configured to estimate (calculate) a channel matrix H by performing channel estimation processing based on CRSs received from a serving cell (a cell 1).

The covariance matrix estimation unit 12 is configured to estimate (calculate) an interference signal component covariance matrix:

\tilde{R}_{I+N} [Expression 5]

based on the CRSs received from the serving cell (cell 1) and the channel matrix H received from the channel estimation 11.

The covariance matrix estimation unit 13 is configured to estimate (calculate) a covariance matrix R_{I+N} based on the channel matrix H received from the channel estimation unit 11 and the interference signal component covariance matrix:

\tilde{R}_{I+N} [Expression 6]

received from the covariance matrix estimation unit 12, as shown in FIG. 2(a).

Each element D (missing element) shown in FIG. 2(a) is, as described earlier, either a covariance value between different resource elements of an SFBC pair or a covariance value between different resource elements of the SFBC pair at different receiving antennas. Thus, the element D cannot be obtained by the CRS-based estimation method for the covariance matrix R_{I+N}.

However, since the elements D do not contain a desired signal component from the serving cell (cell 1), all the values of the element D are supposedly small values.

Thus, the missing element insertion unit 14 is, as shown in FIG. 2(b), configured to insert a fixed value “0” as a given value, into all the elements D in the covariance matrix R_{I+N} received from the covariance matrix estimation unit 13.

The control signal demodulation unit 15 is configured to perform demodulation processing on a control signal received from the serving cell (cell 1).

The IRC reception weight generation unit 16 is configured to generate an IRC reception weight W_{IRC} based on the channel matrix H received from the channel estimation unit 11, the control signal received from the control signal demodulation unit 15, and the covariance matrix R_{I+N} received from the missing element insertion unit 14 (the covariance matrix R_{I+N} having “0” inserted into the elements D).

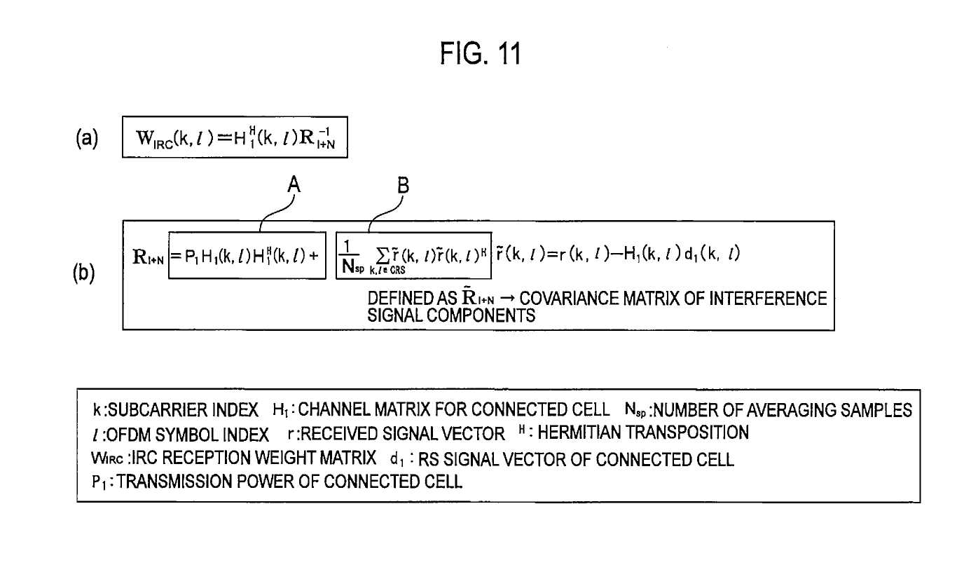

Specifically, the IRC reception weight generation unit 16 is configured to generate the IRC reception weight W_{IRC} by assigning the channel matrix H received from the channel estimation unit 11 and the covariance matrix R_{I+N} received from the missing element insertion unit 14 to the formula shown in FIG. 11(a).

The signal separation unit 17 is configured to perform signal separation processing on a received signal from the serving cell (cell 1), based on the control signal received from the control signal demodulation unit 15 and the IRC reception weight W_{IRC} received from the IRC reception weight generation unit 16.

The demodulation unit 18 is configured to output a data signal by performing demodulation processing on a signal received from the signal separation unit 17, based on the control signal received from the control signal demodulation unit 15 and the IRC reception weight W_{IRC} received from the IRC reception weight generation unit 16.

In the mobile communication system according to the present embodiment, the fixed value “0” is inserted as a given value into an inestimable element in the interference-signal covariance matrix:

\tilde{R}_{I+N}. [Expression 7]

Thus, appropriate reception processing can be performed by use of the CRS-based estimation method for the covariance matrix R_{I+N}.

### (Modification 1)

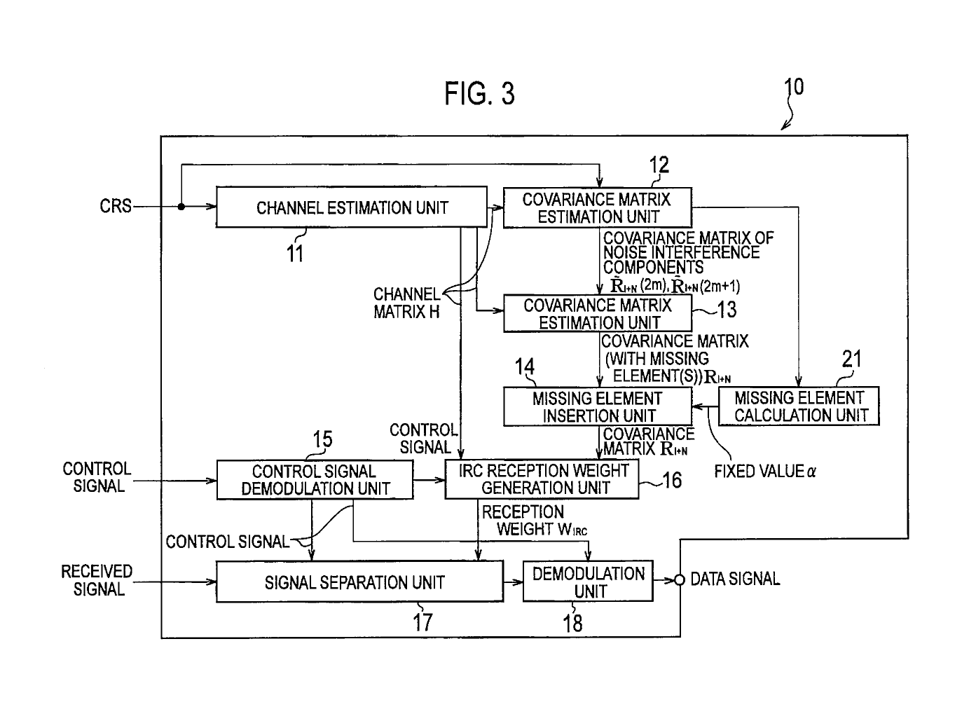

With reference to FIGS. 3 to 5, an IRC receiver 10 according to Modification 1 of the present invention is described. The IRC receiver 10 according to Modification 1 is described below, with a focus on differences from the IRC receiver 10 according to the first embodiment.

As shown in FIG. 3, the IRC receiver 10 according to Modification 1 includes a missing element calculation unit 21 in addition to the configuration shown in FIG. 1.

The missing element calculation unit 21 is configured to calculate a given value to be inserted into each inestimable element D in the interference-signal covariance matrix:

\tilde{R}_{I+N}. [Expression 8]

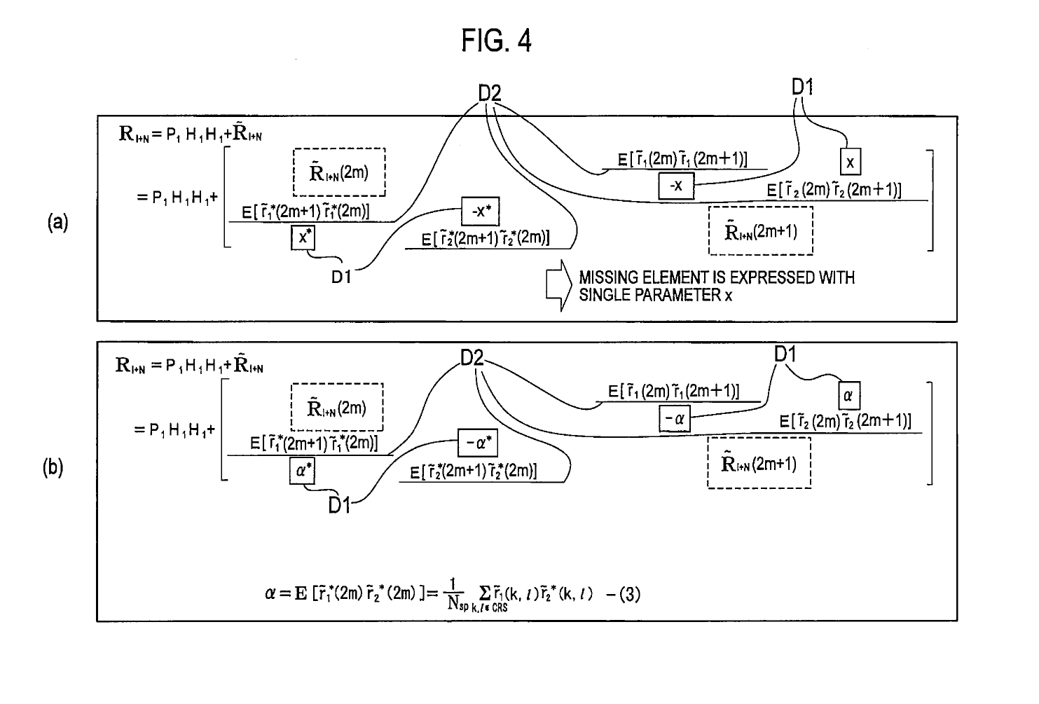

For example, focusing on that an element D1 in the element D can be expressed as a single parameter x as shown in FIG. 4(a), the missing element calculation unit 21 may be configured to use Formula (3) shown in FIG. 4(b) to calculate a given value α (=x) to be inserted into the element D1. Specifically, the missing element calculation unit 21 may be configured to calculate the given value α (=x) to be inserted into the element D1 by using an element of an off-diagonal term in the calculated interference-signal covariance matrix:

\tilde{R}_{I+N}(2m)|. [Expression 9]

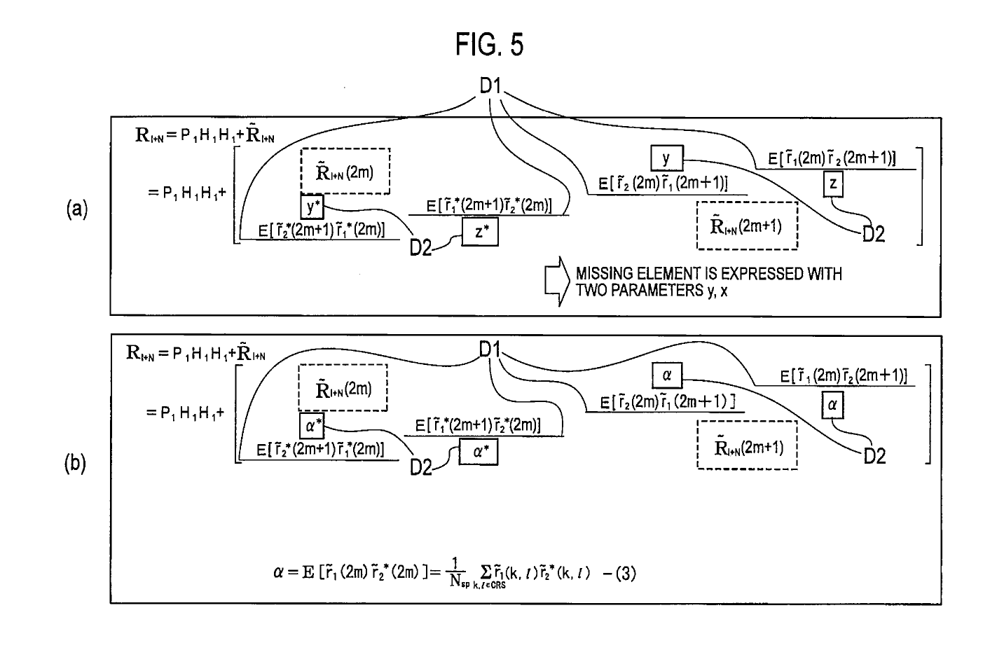

Alternatively, focusing on that an element D2 in the element D can be expressed as two parameters y/z as shown in FIG. 5(a), the missing element calculation unit 21 may be configured to use Formula (3) shown in FIG. 5(b) to calculate the given value α (=y=z). Specifically, the missing element calculation unit 21 may be configured to calculate the given value α (=y=Z) to be inserted into the element D2 by using an element of an off-diagonal term in the calculated interference-signal covariance matrix:

\tilde{R}_{I+N}. [Expression 10]

As shown in FIG. 4(b), the missing element insertion unit 14 may be configured to insert α, αa*, −α, or −α* received from the missing element calculation unit 21 as a given value into each element D1 in the covariance matrix R_{I+N} received from the covariance matrix estimation unit 13.

In this regard, the missing element insertion unit 14 may be configured to insert any one of α, α*, −α, or −α* received from the missing element calculation unit 21 or “0” as a given value into each element D2 in the covariance matrix R_{I+N} received from the covariance matrix estimation unit 13.

Alternatively, as shown in FIG. 5(b), the missing element insertion unit 14 may be configured to insert a given value a or a* into each element D2 in the covariance matrix R_{I+N} received from the covariance matrix estimation unit 13.

In this regard, the missing element insertion unit 14 may be configured to insert any one of α, α*, −α, or —α* received from the missing element calculation unit 21 or “0” as a given value into each element D1 in the covariance matrix R_{I+N} received from the covariance matrix estimation unit 13.

In the mobile communication system according to Modification 1, any one of α, α*, −α, or −α* is inserted as a given value into an inestimable element in the interference-signal covariance matrix:

\tilde{R}_{I+N}. [Expression 11]

Thereby, appropriate reception processing can be performed using the CRS-based estimation method for the covariance matrix R_{I+N}.

### (Modification 2)

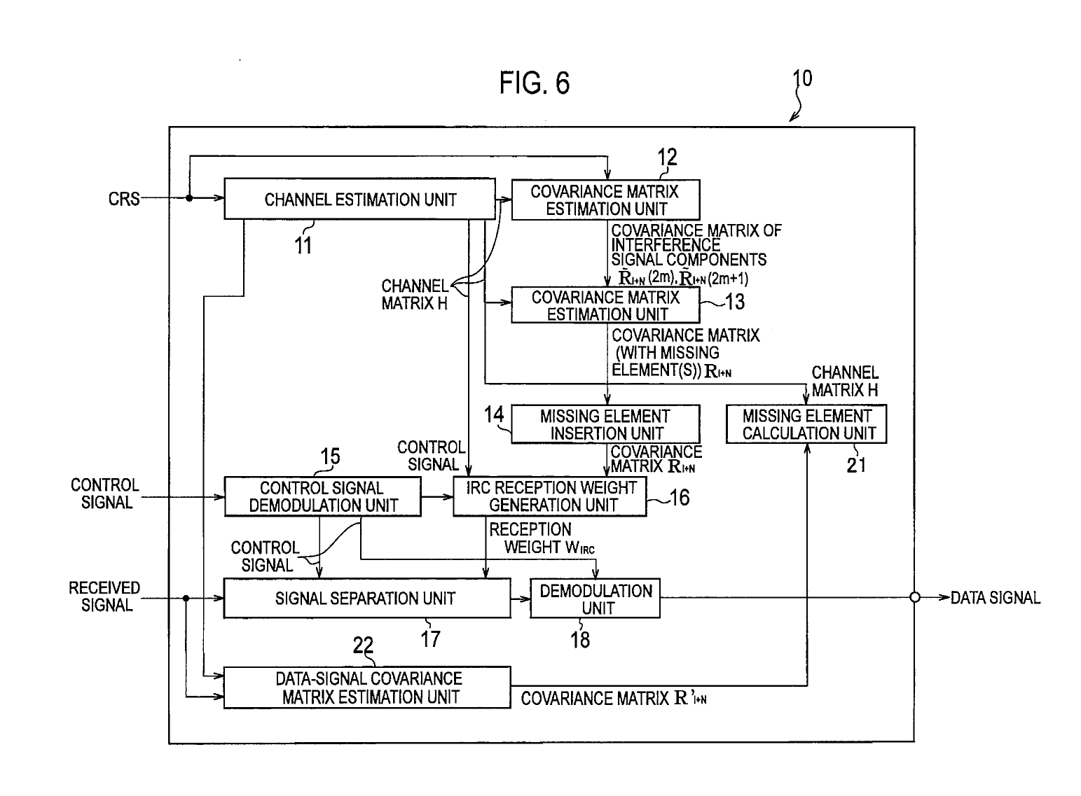

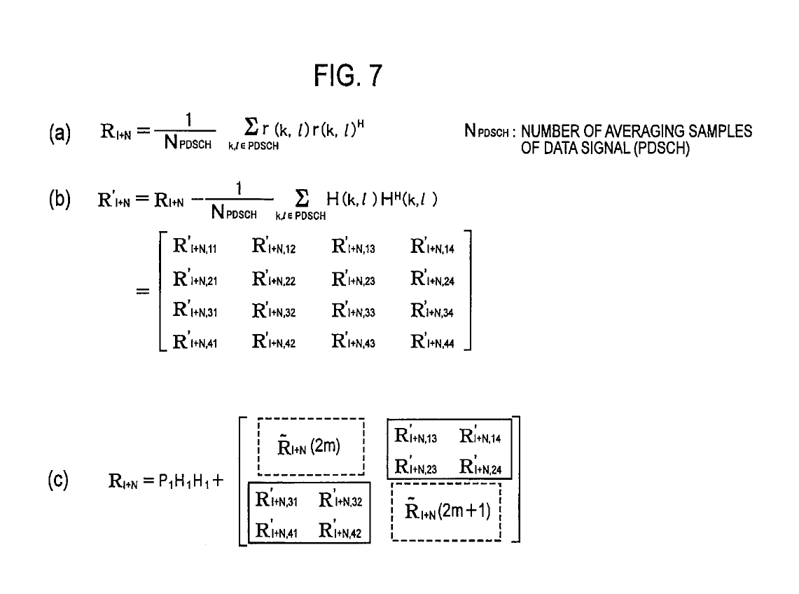

With reference to FIGS. 6 and 7, an IRC receiver 10 according to Modification 2 of the present invention is described. The IRC receiver 10 according to Modification 2 is described below, with a focus on differences from the IRC receiver 10 according to the first embodiment.

As shown in FIG. 6, the IRC receiver 10 according to Modification 2 includes a data-signal covariance matrix estimation unit 22 in addition to the configurations shown in FIGS. 1 and 3.

The data-signal covariance matrix estimation unit 22 is configured to estimate the covariance matrix R_{I+N} based on a received data signal according to FIG. 7(a).

Specifically, the data-signal covariance matrix estimation unit 22 is configured to estimate a data-signal covariance matrix R′_{I+N} according to FIG. 7(b) by using the channel matrix H estimated by the channel estimation unit 11 and the covariance matrix R_{I+N} estimated by the covariance matrix estimation unit 22.

In this regard, the missing element calculation unit 21 is configured to calculate a given value to be inserted into the inestimable element D in the data-signal covariance matrix R′_{I+N} described above.

The missing element insertion unit 14 is, as shown in FIG. 7(c), configured to insert a corresponding element in the data-signal covariance matrix R′_{I+N} received from the missing element calculation unit 21, to each element D in the covariance matrix R_{I+N} received from the covariance matrix estimation unit 13, i.e., the elements D in FIG. 2(a).

In this way, a value of a corresponding element in a covariance matrix estimated by other method (e.g., the data-signal covariance matrix R′_{I+N}) is inserted into an inestimable element in the covariance matrix R_{I+N}. Thereby, appropriate reception processing can be performed using the CRS-based estimation method for the covariance matrix R_{I+N}.

Although the number of antennas of the IRC receiver 10 is “two” in the above embodiment as an example, the present invention can be implemented irrespective of the number of antennas of the IRC receiver 10.

Aspects of the present embodiment described above may be expressed as follows.

A first aspect of the present embodiment is summarized as an IRC receiver 10 configured to receive a data signal, a control signal, and a CRS (cell-specific reference signal) transmitted using an SFBC scheme, the IRC receiver 10 including: a covariance matrix estimation unit 12/13 configured to estimate a covariance matrix R_{I+N} based on the CRS; a missing element insertion unit 14 configured to insert a given value into an inestimable element D in an interference-signal covariance matrix:

\tilde{R}_{I+N} [Expression 12]

of interference signal components contained in the estimated covariance matrix R_{I+N}; an IRS reception weight generation unit 16 configured to generate an IRC reception weight W_{IRC} by using the control signal and the covariance matrix R_{I+N} having the given value inserted thereinto; and a signal separation unit 17 configured to separate the data signal from a received signal by using the generated IRC reception weight and the control signal.

In the first aspect of the present embodiment, the missing element insertion unit 14 may be configured to insert a fixed value “0” as the given value.

In the first aspect of the present embodiment, the missing element insertion unit 14 may be configured to insert, as the given value, a value α, α*, −α, or −α* calculated based on an estimable element in the interference-signal covariance matrix:

\tilde{R}_{I+N}. [Expression 13]

In the first aspect of the present embodiment, the IRC receiver 10 may further include a data-signal covariance matrix estimation unit 22 configured to estimate a covariance matrix:

R′_{I+N} [Expression 13A]

based on the data signal received, and the missing element insertion unit 21 may be configured to insert, as the given value, a corresponding element in the covariance matrix:

R′_{I+N} [Expression 13B]

estimated by the data-signal covariance matrix estimation unit 22 into each element D in the covariance matrix R_{I+N} received from the covariance matrix estimation unit 13.

It should be noted that the foregoing operations of the IRC receiver 10 may be implemented by hardware, may be implemented by a software module executed by a processor, or may be implemented in combination of the two.

The software module may be provided in a storage medium in any format, such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, or CD-ROM.

The storage medium is connected to a processor so that the processor can read and write information from and to the storage medium. Instead, the storage medium may be integrated in a processor. The storage medium and the processor may be provided inside an ASIC. Such an ASIC may be provided in the IRC receiver 10. Otherwise, the storage medium and the processor may be provided as discrete components inside the IRC receiver 10.

Hereinabove, the present invention has been described in detail by use of the foregoing embodiments. However, it is apparent to those skilled in the art that the present invention should not be limited to the embodiments described in the specification. The present invention can be implemented as an altered or modified embodiment without departing from the spirit and scope of the present invention, which are determined by the description of the scope of claims. Therefore, the description of the specification is intended for illustrative explanation only and does not impose any limited interpretation on the present invention.

Note that the entire content of Japanese Patent Application No. 2011-242917 (filed on Nov. 4, 2011) is incorporated by reference in the present specification.

### INDUSTRIAL APPLICABILITY

As described above, the present invention can provide a receiver capable of performing appropriate reception processing by using a CRS-based estimation method for a covariance matrix R_{I+N}.

### EXPLANATION OF THE REFERENCE NUMERALS

10 IRC receiver

11 channel estimation unit

12,13 covariance matrix estimation unit

14 missing element insertion unit

15 control signal demodulation unit

16 IRC reception weight generation unit

17 signal separation unit

18 demodulation unit

21 missing element calculation unit

22 data-signal covariance matrix estimation unit

1. A receiver configured to receive a data signal, a control signal, and a cell-specific reference signal transmitted using a space frequency block coding scheme, the receiver comprising:
a covariance matrix estimation unit configured to estimate a covariance matrix based on the cell-specific reference signal;
a missing element insertion unit configured to insert a given value into an inestimable element in an interference-signal covariance matrix of interference signal components contained in the estimated covariance matrix;
a reception weight generation unit configured to generate a reception weight by using the control signal and the covariance matrix having the given value inserted thereinto; and
a signal separation unit configured to separate the data signal from a received signal by using the control signal and the generated reception weight.

2. The receiver according to claim 1, wherein
the missing element insertion unit is configured to insert a fixed value “0” as the given value.

3. The receiver according to claim 1, wherein
the missing element insertion unit is configured to insert, as the given value, a value calculated based on an estimable element in the interference-signal covariance matrix.

4. The receiver according to claim 1, further comprising
a data-signal covariance matrix estimation unit configured to estimate a covariance matrix based on the data signal received, wherein
the missing element insertion unit is configured to insert, as the given value, a corresponding element in the covariance matrix estimated by the data-signal covariance matrix estimation unit.
